(19) United States
(12) Patent Application Publication
(10) Pub. No.: US 2024/0385843 A1
(43) Pub. Date: Nov. 21, 2024

(54) INFORMATION PROCESSING APPARATUS

(71) Applicant: CANON KABUSHIKI KAISHA, Tokyo (JP)

(72) Inventors: TOMOYUKI KAWAMOTO, Kanagawa (JP); TSEWEI CHEN, Tokyo (JP)

(21) Appl. No.: 18/664,147

(22) Filed: May 14, 2024

(30) Foreign Application Priority Data
May 18, 2023 (JP) 2023-082484

(51) Int. Cl. G06F 9/38; G06F 9/30

(52) U.S. Cl. CPC G06F 9/3885; G06F 9/3001; G06F 9/30032

(57) ABSTRACT

An apparatus comprises: an operation unit including M product-sum operators that can operate in parallel; a memory configured to hold a plurality of coefficients used by the operation unit; and a transfer unit configured to transfer the coefficients held in the memory to the operation unit. The memory holds the plurality of coefficients in accordance with an order of output channels of the operation unit and word alignment of the memory. In a case where the operation unit parallelly executes N arithmetic processes, the transfer unit transfers at least N coefficients to the operation unit in a predetermined transfer format.

### BACKGROUND

### Technical Field

The aspect of the embodiments relates to arithmetic processing using a neural network (NN).

### Description of the Related Art

A method using a hierarchical operation represented by a convolutional neural network (CNN) is receiving attention as a method of recognizing a target object existing in a photo or video. Recognition processing using a CNN and the like includes many product-sum operations, which use most of the processing time. Therefore, an arithmetic device that makes efficiently operate the product-sum operations is used from the viewpoint of increasing speed and saving power.

To perform recognition processing in a device such as a portable terminal or camera that is readily restricted on the memory capacity, a method of holding weight coefficients in a less memory capacity has been examined. For example, a weight coefficient storage method and a CNN with mixed precision that performs processing for each arithmetic processing with appropriate bit precision are proposed.

Japanese Patent No. 6823495 (patent reference 1) proposes a method of facilitating readout of a weight coefficient by arranging weight coefficients of different bit precision at the same address. Japanese Patent Laid-Open No. 2021-9491 (patent reference 2) proposes a method of dividing a memory for holding weight coefficients into two memories so a free area does not exist in a storage area of a memory, and holding weight coefficients in different formats in the memory, respectively. F. Shafiq et al., “Automated flow for compressing convolution neural networks for efficient edge-computation with FPGA”, NIPS 2017, arXiv: 1712.06272 (non-patent reference 1) proposes a method of arranging feature data and weight coefficients in the channel direction of input feature images to improve the use efficiency of a memory and an arithmetic device.

However, in patent reference 1, if a weight coefficient has a bit width that does not match the word alignment of a memory, it is possible that part of the storage area will not be used, leading to an increase in a required memory capacity. In patent reference 2, since weight coefficients are stored in different formats in two memories, a circuit for calculating an address for each memory when reading out a weight coefficient is necessary. In non-patent reference 1, a circuit for a raster scan and channel conversion of input feature images is necessary.

### SUMMARY

According to one aspect of the embodiments, an apparatus comprises: an operation unit including M (M is an integer not less than 2) product-sum operators that can operate in parallel; a memory configured to hold a plurality of coefficients used by the operation unit; and a transfer unit configured to transfer the coefficients held in the memory to the operation unit, wherein the memory holds the plurality of coefficients in accordance with an order of output channels of the operation unit and word alignment of the memory, and in a case where the operation unit parallelly executes N (N is a positive integer not more than M) arithmetic processes, the transfer unit transfers at least N coefficients to the operation unit in a predetermined transfer format.

Further features of the disclosure will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the disclosure and, together with the description, serve to explain the principles of the aspect of the embodiments.

FIG. 1 is a block diagram showing an example of the arrangement of an information processing apparatus;

FIG. 2 is a view showing an example of the configuration of a network to be processed;

FIG. 3 is a block diagram showing an example of the arrangement of a convolutional processing unit;

FIG. 4 is a flowchart of storing weight coefficients;

FIG. 5 is a view showing an example of the storage format of weight coefficients;

FIG. 6 is a block diagram showing an example of the arrangement of a MAC arithmetic unit group;

FIG. 7 is a block diagram showing an example of the arrangement of a MAC arithmetic unit;

FIG. 8 is a flowchart of CNN processing;

FIGS. 9A and 9B are views each showing the transfer format of a weight coefficient (second embodiment);

FIG. 10 is a view showing an example of the storage format of weight coefficients (second embodiment);

FIG. 11 is a block diagram showing an example of the arrangement of a MAC arithmetic unit (second embodiment);

FIGS. 12A and 12B are a flowchart of CNN processing (second embodiment);

FIG. 13 is a block diagram showing an example of the arrangement of a bit width conversion unit;

FIGS. 14A to 14D are views each showing the transfer format of a weight coefficient (third embodiment);

FIG. 15 is a flowchart of storing weight coefficients (third embodiment);

FIGS. 16A and 16B are views each showing an example of the storage format of weight coefficients (third embodiment);

FIG. 17 is a block diagram showing an example of the arrangement of a MAC arithmetic unit (third embodiment);

FIGS. 18A and 18B are a flowchart of CNN processing (third embodiment); and

FIGS. 19A and 19B are views each showing an example of the operation of the MAC arithmetic unit (third embodiment).

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

### First Embodiment

As the first embodiment of an information processing apparatus according to the disclosure, an information processing apparatus that performs arithmetic processing using a convolutional neural network (CNN) will be described below as an example.

### Arrangement of Apparatus

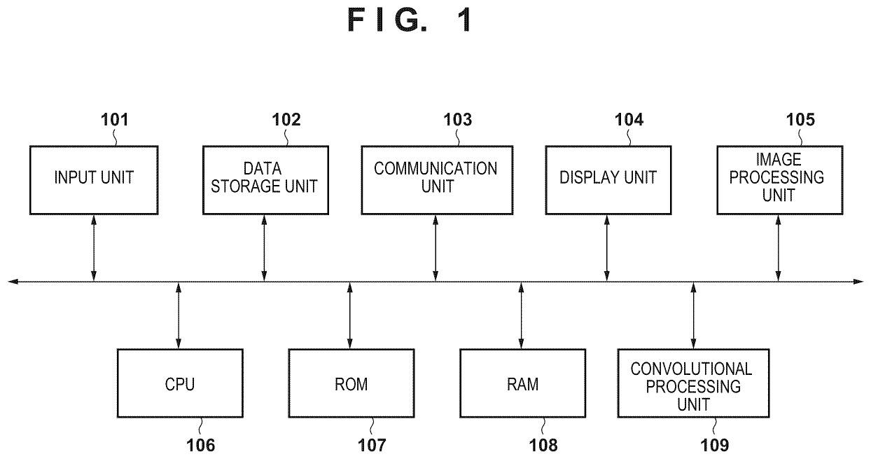

FIG. 1 is a block diagram showing an example of the arrangement of an information processing apparatus. Note that respective units shown in FIG. 1 are included in a single apparatus, but may be distributed to a plurality of apparatuses connected by a communication path.

An input unit 101 is a device used by the user to input instructions and data, and includes a keyboard, a pointing device, and buttons. Alternatively, a display unit 104 and the input unit 101 may be implemented by the same device, like a known touch screen device. In this case, input to the touch screen may be processed as input to the input unit 101.

A data storage unit 102 is a portion that stores image data. The data storage unit 102 is normally formed by a hard disk, a flexible disk, an optical disk, a flash memory, or the like. The data storage unit 102 can store programs and other data in addition to the image data. Alternatively, a part of a RAM 108 (to be described later) may be used as the data storage unit 102. Alternatively, a storage device connected by a communication unit 103 (to be described later) may virtually be configured to be used via the communication unit 103.

The communication unit 103 is an I/F for performing communication between apparatuses. The display unit 104 is a device that displays an image before or after image processing, or displays an image such as a graphical user interface (GUI), and a CRT, a liquid crystal display, or the like is generally used. Alternatively, the display unit 104 may be a display device connected by a cable or the like outside the apparatus.

An image processing unit 105 is a processing unit that receives a command from a CPU 106, reads out image data written in the data storage unit 102, performs range adjustment of pixel values, and then writes again the result in the RAM 108.

The CPU 106 is a device that controls the overall operation of the apparatus. A ROM 107 and the RAM 108 provide, to the CPU 106, a program, data, and a work area for processing. If the program for processing (to be described later) is stored in the data storage unit 102 or the ROM 107, the program is temporarily loaded into the RAM 108 and then executed. Alternatively, if the apparatus receives the program via the communication unit 103, the program is executed after being temporarily recorded in the data storage unit 102 and then loaded into the RAM 108 or after being loaded from the communication unit 103 into the RAM 108 directly.

A convolutional processing unit 109 is a device that processes product-sum operations concerning a CNN. The convolutional processing unit 109 receives a command from the CPU 106, performs CNN processing including product-sum operations for the result of the image processing stored in the RAM 108, and writes the result in the RAM 108. The CPU 106 performs image processing or image recognition based on the result of the CNN processing, and records the result in the RAM 108.

### Network Configuration

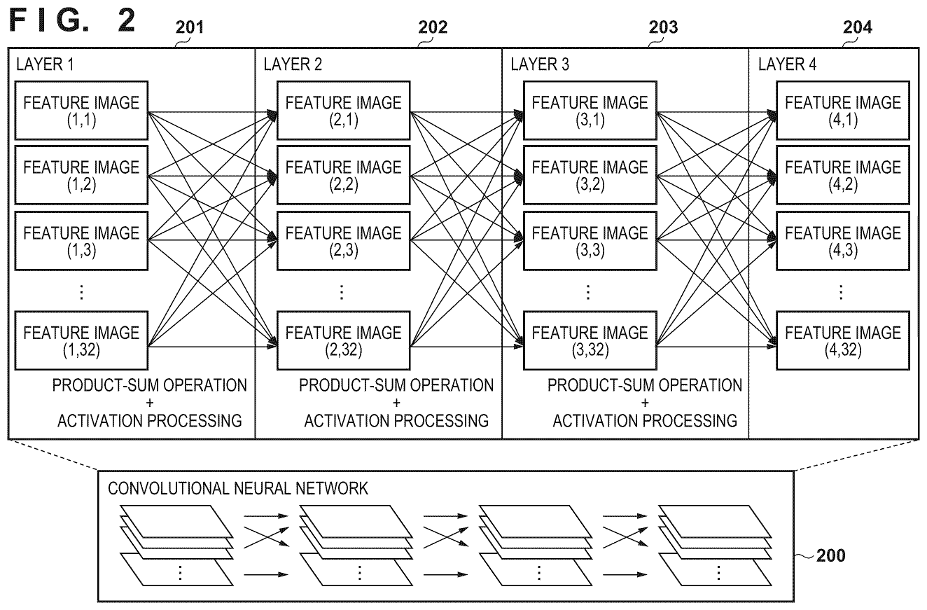

FIG. 2 is a view showing an example of the configuration of the network of the convolutional processing unit 109. The network structure is characterized by information (the connection relationship between layers, the size and channel count of feature images, the bit width of feature data, the size of a filter, the bit width of a weight coefficient, and the like) of each layer. A CNN 200 indicates a CNN including four layers (layers 1 to 4). Each layer includes feature images of 32 channels and a filter formed by a plurality of weight coefficients.

Calculation contents in layers 1 to 4 will be described. In layer 1, a product-sum operation result O(n) is obtained using feature images I(m) of a plurality of channels and a filter C(m, n) in a layer 201 based on equation (1) below. Furthermore, by performing activation processing, pooling processing, and the like, feature images of a plurality of channels in a layer 202 in layer 2 are generated.

$${O}_{i , j} ( n ) = {\sum }_{m = 1}^{M} {\sum }_{x = 0}^{X - 1} {\sum }_{y = 0}^{Y - 1} ( {I}_{i - \frac{X - 1}{2} + x , j - \frac{Y - 1}{2} + y} ( m ) \times {C}_{x , y} ( m , n ) ) \qquad ( 1 )$$

Similarly, product-sum operation results are obtained using feature images and a filter in each of layers 2 to 4, and activation processing, pooling processing, and the like are performed to generate feature images of a plurality of channels. By repeating generation of feature images for each layer in this way, the processing result of the CNN is obtained.

Variables in equation (1) will be described. A variable m represents the number of a feature image I in a preceding layer, and a variable M represents the channel count of the feature images in the preceding layer. A variable n represents the number of a feature image O in a current layer, variables i and j represent the coordinates of the feature data of the feature image I or O, variables x and y represent the coordinates of a weight coefficient of a filter C, and variables X and Y represent the size of the filter.

### Arrangement of Convolutional Processing Unit

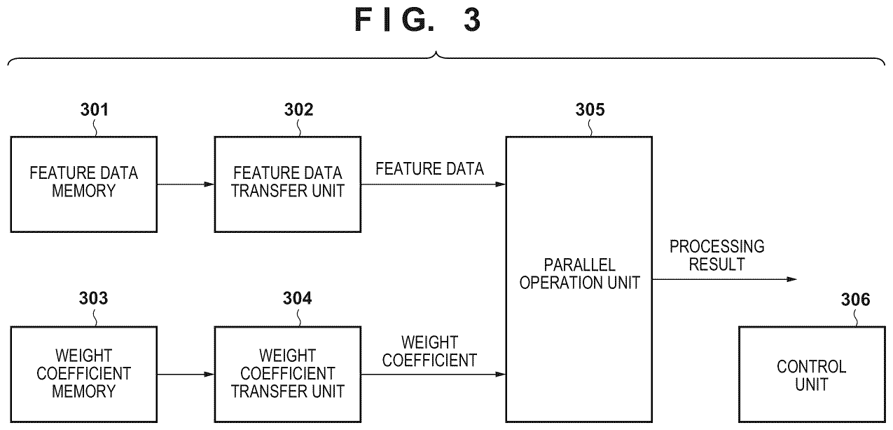

FIG. 3 is a block diagram showing an example of the arrangement of the convolutional processing unit 109. The convolutional processing unit 109 is formed by a feature data memory 301, a feature data transfer unit 302, a weight coefficient memory 303, a weight coefficient transfer unit 304, a parallel operation unit 305, and a control unit 306.

The feature data memory 301 temporarily holds the input feature images I(m) of the plurality of channels. The feature data transfer unit 302 reads out, from the feature data memory 301, a plurality of feature data to be used for product-sum operations executed by the parallel operation unit 305 and transmits them to the parallel operation unit 305.

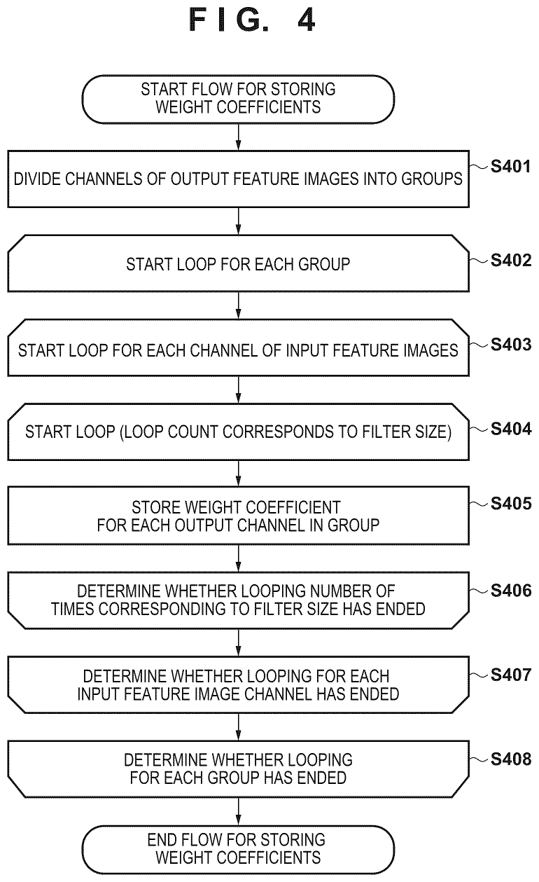

The weight coefficient memory 303 temporarily holds a plurality of weight coefficients C(m, n). The weight coefficient memory 303 is formed by, for example, an SRAM. One layer includes X×Y×M×N weight coefficients, and the overall network includes weight coefficients as many as a value obtained by adding the numbers of weight coefficients for all the layers. A network to be processed is not limited to the structure shown in FIG. 2. A network may include more layers and more feature images. In this case, more weight coefficients are stored. By storing weight coefficients in accordance with a flowchart shown in FIG. 4 to be described later, it is possible to efficiently store the weight coefficients in the memory.

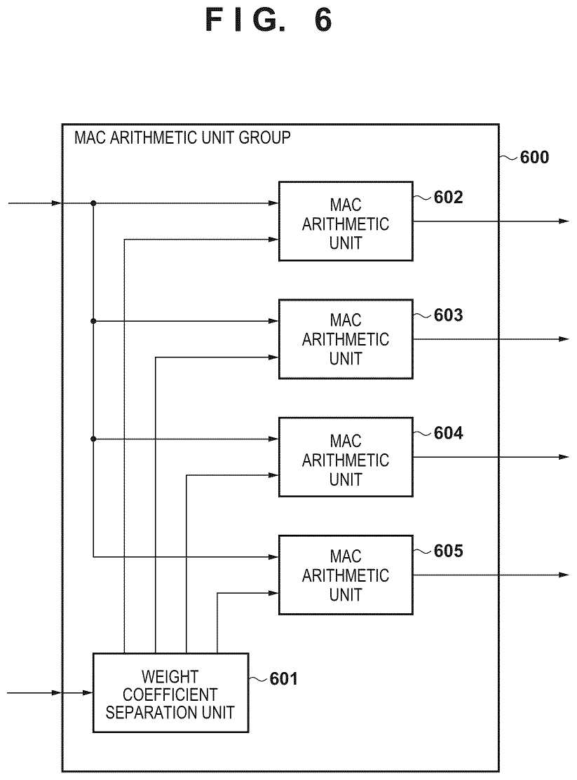

The weight coefficient transfer unit 304 reads out, from the weight coefficient memory 303, a plurality of weight coefficients to be used for product-sum operations executed by the parallel operation unit 305, and transmits them to the parallel operation unit 305. The parallel operation unit 305 executes product-sum operations, activation processing, and pooling processing using the plurality of received feature data and the plurality of received weight coefficients. With an arrangement shown in FIG. 6 to be described later, it is possible to efficiently, parallelly execute product-sum operations, thereby suppressing an increase in power consumption.

The control unit 306 holds network structure information, and controls the operation of the convolutional processing unit 109.

### Storage Format of Weight Coefficient

The storage format of the weight coefficient of the convolutional network held in the weight coefficient memory 303 will be described. An issue arising at the time of storing coefficients will be described by exemplifying a case where the word length (a bit count per word) of the weight coefficient memory 303 is 32 bits, the size of the filter is 3×3, and the bit width of a weight coefficient is 8 bits (bit width CA).

If nine weight coefficients included in the 3×3 filter are densely stored for respective pixels, four weight coefficients are stored in each of the first and second words, and one weight coefficient is stored in the third word. If the next filter is subsequently stored, three weight coefficients are stored in the free area of the third word, four weight coefficients are stored in the fourth word, and two weight coefficients are stored in the fifth word. At this time, since the storage bit positions are different between the first filter and the second filter, a circuit for switching the extraction bit positions of the weight coefficients is used to extract necessary weight coefficients.

As another storage method, if the second filter is stored from the fourth word so as to align the extraction bit positions of the weight coefficients, an unused area of 24 bits exists in the third word. Even if three weight coefficients are arranged in each word, an unused area of 8 bits exists in each word. If an unused area exists in this way, this increases the memory capacity.

FIG. 4 is a flowchart of storing weight coefficients according to the first embodiment. The first embodiment will exemplify a case where the bit widths of weight coefficients are all the same.

In step S401, the control unit 306 divides the channel count of output feature images in a layer to be processed into groups by the number of weight coefficients fit in one word of the weight coefficient memory 303. If one word includes 32 bits and a weight coefficient includes 8 bits, the channels are divided into groups by every four channels.

In step S402, the control unit 306 starts a loop to store the weight coefficients for each divided group. First, four channels of n=0 to 3 are targets as the first group created in step S401.

In step S403, the control unit 306 starts a loop to store weight coefficients as many as the channel count of input feature images in the layer to be processed. In the example shown in FIG. 2, the channel count of the input feature images is 32 and the loop is repeated 32 times.

In step S404, the control unit 306 starts a loop to store weight coefficients as many as the filter size. If the filter size is 3×3, the loop is repeated nine times.

In step S405, the control unit 306 stores weight coefficients as many as the output channel count in the group. In this example, the weight coefficients for four channels are stored in accordance with the channel count in the group. This is data fit in one word.

In step S406, the control unit 306 determines whether the loop has been repeated as many times as the filter size. If the weight coefficients have been stored for all pixels of the filter, the process advances to step S407; otherwise, the process returns to step S404 to start storing the weight coefficient for the next pixel.

In step S407, the control unit 306 determines whether the loop has been repeated as many times as the channel count of the input feature images. If the loop has been repeated for all the channels of the input feature images in the layer to be processed, the process advances to step S408; otherwise, the process returns to step S403 to start storing the weight coefficient for the input feature image of the next channel.

In step S408, the control unit 306 determines whether the loop has been repeated for the divided groups. If the weight coefficients have been stored for all the divided groups, the storage of the weight coefficients ends; otherwise, the process returns to step S402 to start storing the weight coefficient for the next group. With the above processing, the plurality of weight coefficients are held in accordance with the order of the output channels of the parallel operation unit 305 and the word alignment of the weight coefficient memory 303.

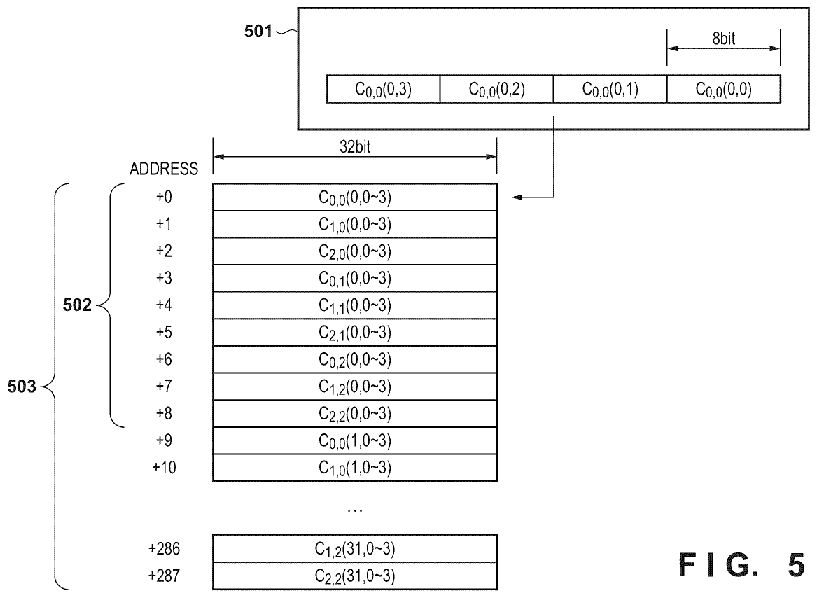

FIG. 5 is a view showing an example of the storage format of weight coefficients according to the first embodiment. That is, FIG. 5 shows the structure of the weight coefficients stored in the weight coefficient memory 303 in accordance with the above-described steps.

Weight coefficients of the output feature images as many as the channel count included in the group stored in step S405 are stored in a word. Weight coefficients at coordinates (0, 0) of the filter corresponding to channels 0 to 3(four channels in total) of the output feature image are stored in a first word 501.

Weight coefficients for nine pixels corresponding to the filter size of 3×3 are stored in an area 502 of the first to ninth words by the loop of step S404. Weight coefficients for 32 channels of the input feature images are stored in an area 503 of the first to 288th words by the loop of step S403.

If the channel count of the output feature images included in the layer to be processed is four or more, the weight coefficients for the second group of the channels of the output feature images divided in step S401 are stored in the same format from the 289th word.

As described above, the weight coefficients sequentially referred to in the channel direction of the output feature images are arranged in each word. This can store the weight coefficients without generating an unused area in each word regardless of the filter size, and can readily specify the bit position of the weight coefficient in accordance with the channel number.

The word length of the weight coefficient memory 303 is exemplified as 32 bits. However, the bit count is not limited to this. For example, the bit count of one word may further be increased, thereby shortening the time taken to store the weight coefficients.

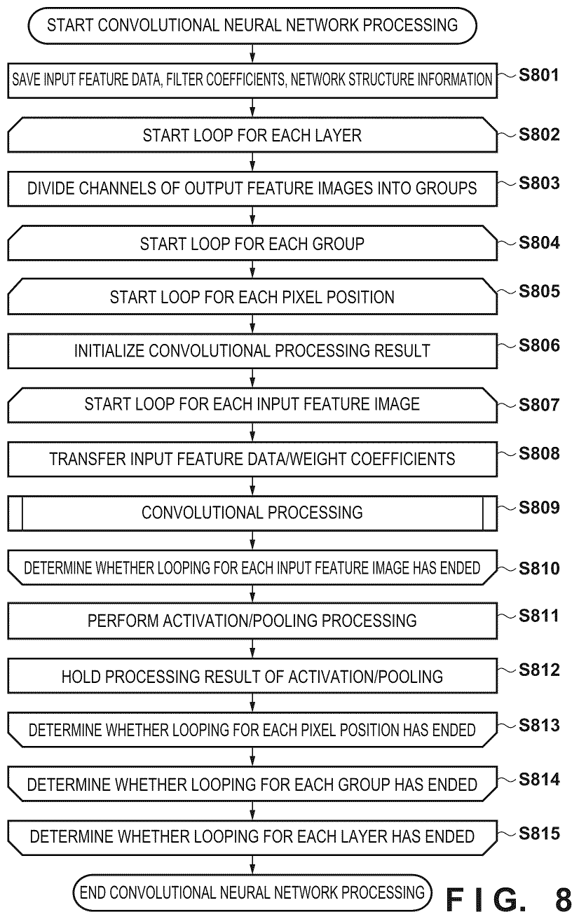

In addition, weight coefficients learned in advance may be stored in the data storage unit 102 or the ROM 107 in accordance with the flowchart shown in FIG. 4, and then stored in the weight coefficient memory 303 when executing convolutional processing shown in FIG. 8.

### Arrangement of Parallel Operation Unit 305

FIG. 6 is a block diagram showing an example of the arrangement of a MAC arithmetic unit group as the parallel operation unit 305. The parallel operation unit 305 includes a MAC arithmetic unit group 600 including M (M is an integer of 2 or more) MAC arithmetic units that can operate in parallel. Multiply and Accumulation (MAC) means a product-sum operation.

The MAC arithmetic unit group 600 serves as a circuit that parallelly processes feature data of one pixel of a plurality of channels of output feature images, and includes a weight coefficient separation unit 601 and a plurality of MAC arithmetic units 602 to 605. The MAC arithmetic unit group 600 includes MAC arithmetic units as many as the channel count of output feature images to be parallelly processed, and copies and inputs the feature data transferred from the feature data transfer unit 302 to the respective MAC arithmetic units. Since each MAC arithmetic unit can use the copied common feature data, it is possible to reduce the band usage concerning transfer of the input data.

The weight coefficient separation unit 601 separates, for each channel, the weight coefficients for the plurality of channels transferred from the weight coefficient transfer unit 304 and transmits them to the respective MAC arithmetic units. More specifically, if the first word 501 of the weight coefficient memory 303 is transferred, a weight coefficient C_{0,0}(0, 0) of the first channel is transmitted to the MAC arithmetic unit 602. Similarly, a weight coefficient C_{0,0}(0, 1) of the second channel is transmitted to the MAC arithmetic unit 603, a weight coefficient C_{0,0}(0, 2) of the third channel is transmitted to the MAC arithmetic unit 604, and a weight coefficient C_{0,0}(0, 3) of the fourth channel is transmitted to the MAC arithmetic unit 605.

Since the bit position for each channel in the word corresponds to each MAC arithmetic unit, in one embodiment, the weight coefficient separation unit 601 connects the bit of the input weight coefficient to the corresponding MAC arithmetic unit. That is, a circuit that switches a bit extraction position is not required.

By receiving, for each word, the weight coefficients arranged in the order of the output feature images, as shown in FIG. 5, the weight coefficient separation unit 601 can distribute the weight coefficient of each channel included in the received weight coefficients to each MAC arithmetic unit. Therefore, in one embodiment, the weight coefficient transfer unit 304 sequentially read out the weight coefficients from the weight coefficient memory 303 while incrementing the address of the target filter from the start address and transmit them, and can thus be formed by a simple circuit.

Note that the aspect of the embodiments is not limited to a case where the channel count of the weight coefficients included in each word of the weight coefficient memory 303 is equal to the number of MAC arithmetic units included in the MAC arithmetic unit group 600. For example, the weight coefficient transfer unit 304 may reduce the number of weight coefficients to be transmitted in accordance with the number of MAC arithmetic units included in the MAC arithmetic unit group 600, thereby reducing the scale of the arithmetic unit or a transmission path.

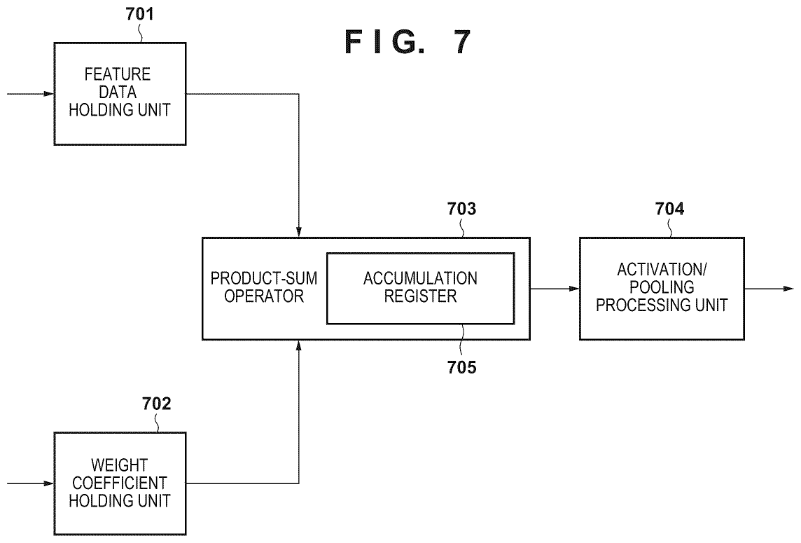

FIG. 7 is a block diagram showing an example of the arrangement of the MAC arithmetic unit according to the first embodiment. The MAC arithmetic unit is formed by a feature data holding unit 701, a weight coefficient holding unit 702, a product-sum operator 703, and an activation/pooling processing unit 704.

The weight coefficient holding unit 702 holds a weight coefficient C_{x,y}(m, n), and the feature data holding unit 701 holds a feature image I(m). The product-sum operator 703 calculates a convolutional processing result from the weight coefficients and the feature data based on equation (1), and stores it in an accumulation register 705. The activation/pooling processing unit 704 calculates an activation/pooling processing result based on the convolutional processing result.

### Arithmetic Processing (CNN Processing) Operation Using CNN

FIG. 8 is a flowchart of CNN processing. Steps S801 to S815 correspond to the control operation of a CPU, a sequencer, or the like included in the control unit 306. Each step of the flowchart will be described based on the arrangement of the convolutional processing unit 109.

In step S801, the control unit 306 reads out the feature data of the input feature images, the weight coefficients of the filter, and the network structure information from the RAM 108. Then, the readout feature data are held in the feature data memory 301, the weight coefficients are held in the weight coefficient memory 303, and the network structure is held in the control unit 306.

In step S802, the control unit 306 starts a loop for each layer. Layer 1 is processed first.

In step S803, the control unit 306 divides the output feature data in the layer into groups by every number of channels parallelized in the MAC arithmetic unit group 600. The MAC arithmetic unit group 600 of this embodiment includes four MAC arithmetic units, and thus the output feature data are grouped by every four channels.

In step S804, the control unit 306 starts a loop for each group divided in step S803. In this embodiment, since the data are grouped by every four channels, the 0th to third channels of the output feature images are processed first.

In step S805, the control unit 306 starts a loop for each pixel position. The control unit 306 repeatedly processes the entire image so as to output the output feature image for each pixel. If the parallel operation unit 305 is formed by a plurality of MAC arithmetic unit groups 600, the loop is repeated while parallelly processing pixels of output feature images as many as the number of MAC arithmetic unit groups 600.

In step S806, the control unit 306 performs initialization by setting, to zero, the convolutional processing result held in the accumulation register 705 of each MAC arithmetic unit.

In step S807, the control unit 306 starts a loop for each input feature image, and sequentially processes the input feature data in the layer. The control unit 306 first processes the input feature data of the first channel.

In step S808, the control unit 306 controls the feature data transfer unit 302 to read out the input feature image to be processed from the feature data memory 301, and transfers the input feature image to the parallel operation unit 305. If the filter size is 3×3, the feature data transfer unit 302 first transmits feature data included at coordinates (0, 0) to (2, 2). At the same time, the control unit 306 controls the weight coefficient transfer unit 304 to read out, from the weight coefficient memory 303, the weight coefficients for the input feature image to be processed, and transfers the weight coefficients to the parallel operation unit 305. If the parallel operation unit 305 parallelly executes N (N is a positive integer equal to or smaller than M) arithmetic processes, at least N weight coefficients are transferred to the parallel operation unit 305.

If the filter size shown in FIG. 5 is 3×3, the input feature image of the first channel is to be processed, and the output feature images of the first to fourth channels are to be processed, the first to 36th words 503 are read out and transmitted. The transmitted feature data are copied to the respective MAC arithmetic units in the MAC arithmetic unit group 600, as described above, and held in the respective feature data holding units 701. The transmitted weight coefficients of the plurality of channels are distributed to the MAC arithmetic units for the respective channels, and held in the respective weight coefficient holding units 702. If the plurality of MAC arithmetic unit groups 600 are provided to parallelize the processes in the spatial direction of the feature image, feature data corresponding to output coordinates is transmitted to each MAC arithmetic unit group. As an example, if two MAC arithmetic unit groups are provided, feature data corresponding to coordinates obtained when i of equation (1) is an even number is assigned to MAC arithmetic unit group 0, and feature data corresponding to coordinates obtained when i is an odd number is assigned to MAC arithmetic unit group 1.

In step S809, the control unit 306 transmits a control signal to execute convolutional processing to the product-sum operator 703 of each MAC arithmetic unit. The product-sum operator 703 of each MAC arithmetic unit calculates a convolutional processing result based on equation (1) using the input feature data held in the feature data holding unit 701 and the weight coefficients held in the weight coefficient holding unit 702.

In step S810, the control unit 306 determines the end of the loop for each input feature image. If the processing of all the input feature data ends, the process advances to step S811; otherwise, the process returns to step S807 to start processing of the next input feature image.

In step S811, the control unit 306 transmits a control signal to execute activation/pooling processing to the activation/pooling processing unit 704 of each MAC arithmetic unit. The activation/pooling processing unit 704 of each MAC arithmetic unit performs activation processing based on the convolutional processing result held in the product-sum operator 703. In this example, an activation processing result is calculated by:

$$f ( x ) = \{ \begin{matrix}0 , & x < 0 \\ x , & x \geq 0\end{matrix} \qquad ( 2 )$$

where f(x) represents an activation function, and x represents input data. In this example, the activation function is implemented using Rectified Linear Unit (ReLU). However, the aspect of the embodiments is not limited to ReLU, and the activation function may be implemented by another nonlinear function or quantization function. Furthermore, the activation/pooling processing unit 704 performs pooling processing based on the result of the activation processing in accordance with the information of the layer, and adjusts the size of the output feature image, as needed.

In step S812, the control unit 306 holds the activation/pooling processing result in the feature data memory 301, and processes it as the feature image of the next layer.

In step S813, the control unit 306 determines the end of the loop for each pixel position. If the processing of all the pixels ends, the process advances to step S814; otherwise, the process returns to step S805 to process the next pixel position.

In step S814, the control unit 306 determines the end of the loop for each output feature image group. If the processing of all the output feature image groups ends, the process advances to step S815; otherwise, the process returns to step S804 to start processing of the next output feature image group.

In step S815, the control unit 306 determines the end of the loop for each layer. If the processing of all the layers ends, the CNN processing ends; otherwise, the process returns to step S802, and the layer to be processed is changed to start processing of the next layer.

As described above, according to the first embodiment, the weight coefficients are arranged and stored in the channel direction of the output feature images. This can arrange the weight coefficients in the weight coefficient memory 303 without any space, thereby efficiently using the memory. In addition, the parallel operation unit 305 includes the MAC arithmetic unit group that parallelly processes the feature data in the channel direction of the output feature images, and includes the accumulation register in each MAC arithmetic unit. Therefore, it is possible to efficiently execute arithmetic processing along with the storage format of the weight coefficients. In addition, since the configuration can extend also in the spatial direction of the feature image without deteriorating the execution efficiency of the arithmetic processing, this is applicable to the CNN arrangement that requires high-speed processing.

### Second Embodiment

The second embodiment will describe an arrangement in a case where weight coefficients of different bit widths are used. A description of the same configurations as those in the first embodiment will be omitted.

### Network Configuration

Assume that the network configuration has the same structure as in the first embodiment (FIG. 2). Note that a case where only the bit width of weight coefficients in layer 1 is 1 bit and the bit widths of weight coefficients in other layers are 8 bits will be exemplified.

### Arrangement of Convolutional Processing Unit

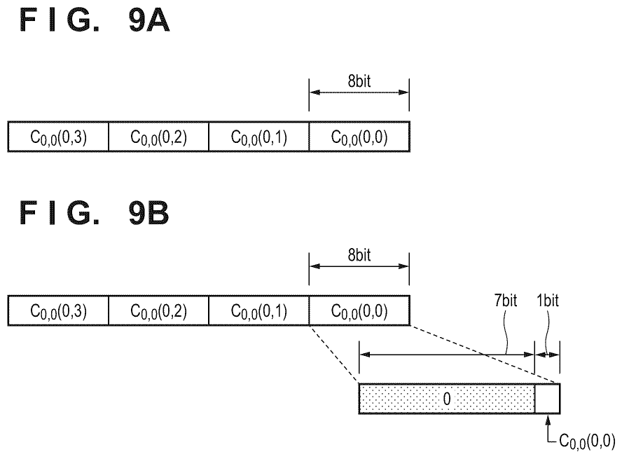

Assume that the arrangement of a convolutional processing unit 109 is the same as in the first embodiment (FIG. 3). Note that a weight coefficient transfer unit 304 converts weight coefficients into a transfer format shown in FIG. 9A or 9B in accordance with the bit width of each weight coefficient, and transmits them to a parallel operation unit 305. As the transfer format, the number of weight coefficients to be transmitted to the parallel operation unit 305 is equal to the number of MAC arithmetic units included in a MAC arithmetic unit group regardless of the bit width, and the arrangement of the weight coefficients changes in accordance with the bit width.

FIGS. 9A and 9B are views each showing a predetermined transfer format of the weight coefficients according to the second embodiment. FIG. 9A shows a transfer format in a case where each weight coefficient includes 8 bits (bit width CA). If a MAC arithmetic unit group 600 includes four MAC arithmetic units, four 8-bit weight coefficients are transmitted. On the other hand, FIG. 9B shows a transfer format in a case where each weight coefficient includes 1 bit (bit width CB). If the MAC arithmetic unit group 600 includes four MAC arithmetic units, each 1-bit weight coefficient is arranged in the least significant bit for every 8 bits. As described above, if M MAC arithmetic units are included, the transfer format is configured to include M fixed-length fields regardless of the bit width of each weight coefficient.

The format of the weight coefficients is converted, as described above, and then the weight coefficients are transmitted to the parallel operation unit 305. This allows a weight coefficient separation unit 601 in the MAC arithmetic unit group 600 to distribute the weight coefficients for each channel to each MAC arithmetic unit, regardless of the bit width of each weight coefficient.

### Storage Operation and Storage Format of Weight Coefficients

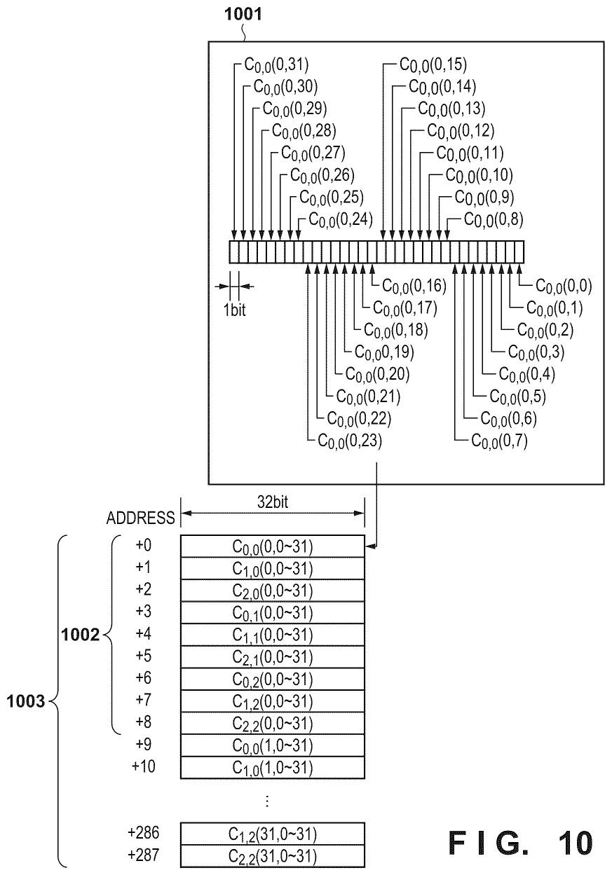

A weight coefficient storage flowchart is the same as in the first embodiment (FIG. 4). The 8-bit weight coefficients in layers 2 to 4 are stored in a weight coefficient memory 303 in the same storage format as in the first embodiment (FIG. 5). The storage format of the 1-bit weight coefficients in layer 1 will be described with reference to FIG. 10.

FIG. 10 is a view showing an example of the storage format of the weight coefficients according to the second embodiment. That is, FIG. 10 shows the structure of the 1-bit (CB-bit) weight coefficients in layer 1, which are stored in the weight coefficient memory 303 in accordance with a flowchart shown in FIG. 4.

If the word length of the weight coefficient memory 303 is 32 bits, and each weight coefficient includes 1 bit, the channels of output feature images are grouped by every 32 channels in step S401. In step S405, the weight coefficients for 32 channels are stored in one word. C_{0,0}(0, 0) to C_{0,0}(0, 31) are stored in a first word 1001. If the filter size is 3×3, regardless of the bit width, the weight coefficients for nine pixels are stored in an area 1002 of the first to ninth words and the weight coefficients for 32 channels of input feature images are stored in an area 1003 of the first to 288th words.

As described above, the weight coefficients are sequentially stored in the channel direction of the output feature images regardless of the bit width (1 or 8bits) of each weight coefficient in the word of the weight coefficient memory 303. That is, in each word area, WD/CA 8-bit weight coefficients or WD/CB 1-bit weight coefficients are held. This can store the weight coefficients without generating an unused area in the word of the weight coefficient memory 303 even if the weight coefficients of a plurality of bit widths are handled. Furthermore, the pixel position of each weight coefficient may be independent of the bit width of the weight coefficient.

### Arrangement of Parallel Operation Unit 305

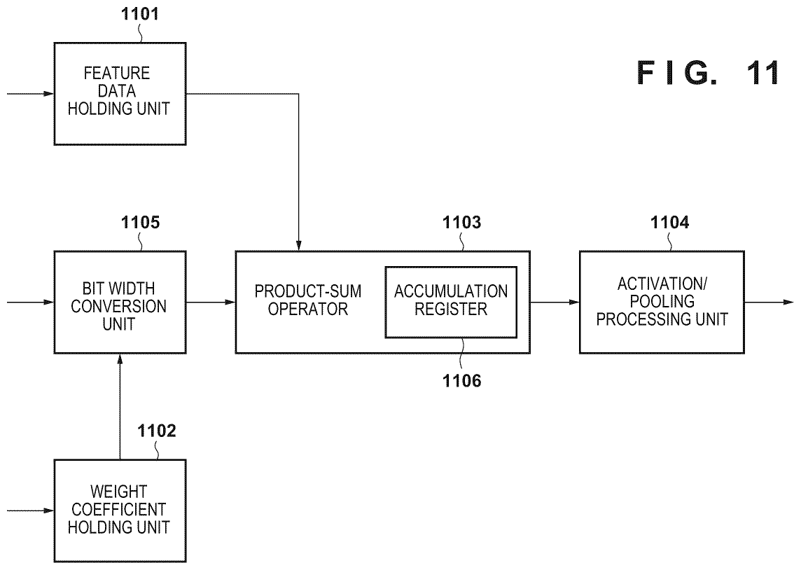

FIG. 11 is a block diagram showing an example of the arrangement of the MAC arithmetic unit according to the second embodiment. The MAC arithmetic unit according to the second embodiment has an arrangement obtained by adding a bit width conversion unit 1105 to the arrangement (FIG. 7) of the first embodiment.

In accordance with a weight coefficient to be processed, which is designated from a control unit 306, the bit width conversion unit 1105 converts the weight coefficient into an 8-bit weight coefficient and transmits it to a product-sum operator 1103. This allows the product-sum operator 1103 to process the 1-bit weight coefficient and the 8-bit weight coefficient in the same arithmetic unit, thereby suppressing an increase in circuit scale due to implementation of arithmetic units for different bit widths.

### Arithmetic Processing Operation Using CNN

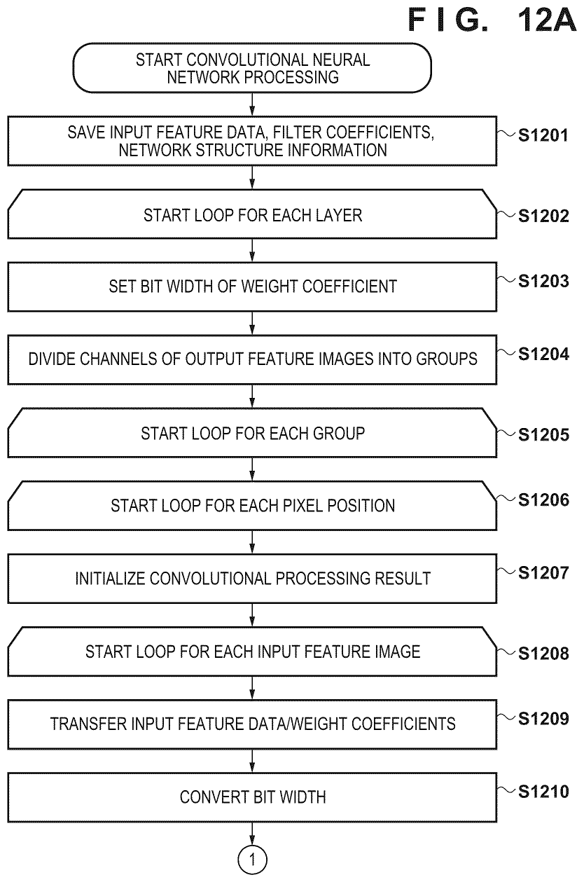

FIGS. 12A and 12B are a flowchart of CNN processing according to the second embodiment. The flowchart according to the second embodiment is obtained by adding steps S1203 and S1210 to the first embodiment (FIG. 8). Steps different from the first embodiment will be described below.

In step S1203, the control unit 306 sets the bit widths of the weight coefficients in the bit width conversion unit 1105 in accordance with held network structure information. In this example, the bit widths of the weight coefficients in the same layer are the same but a different bit width may be set for each output feature image. In a case where the output feature images are divided into a plurality of groups, the bit width of the weight coefficient is set for each group and parallel processing is performed on a group basis, thereby making it possible to improve processing efficiency.

In step S1209, the control unit 306 controls the feature data transfer unit 302 to read out an input feature image to be processed from the feature data memory 301, and transfers the input feature image to be processed to the parallel operation unit 305. Along with this, the control unit 306 controls the weight coefficient transfer unit 304 to read out, from the weight coefficient memory 303, weight coefficients for the input feature image to be processed, converts each weight coefficient into the transfer format shown in FIG. 9A or 9B in accordance with the bit width of the weight coefficient, and transfers the weight coefficients to the parallel operation unit 305.

In step S1210, the control unit 306 transmits a control signal to execute bit width conversion processing to the bit width conversion unit 1105. The bit width conversion unit 1105 converts each weight coefficient based on the held weight coefficients and information of the bit width of the weight coefficient.

If the bit width of each weight coefficient is not 1 bit (that is, 8 bits), a weight coefficient C_{x,y}(m, n) is not converted. If the bit width of each weight coefficient is 1 bit, a value of “0” or “1” held in the weight coefficient memory 303 may be used intact to perform processing. However, in this case, it is impossible to display a negative number. In a case where a weight coefficient having a value of “0” or “1” is used in convolutional processing in which the bit width is 1 bit, it is difficult to improve recognition accuracy, and thus a weight coefficient having a value of “−1” or “+1” is often used. In this embodiment, before performing convolutional processing, the bit width conversion unit 1105 converts the weight coefficient C_{x,y}(m, n) by equation (3) below. That is, a weight coefficient having a value of “0” is converted into “1”, and a weight coefficient having a value of “1” is “+1”.

$${C}_{x , y}^{′} ( m , n ) = \{ \begin{matrix}- 1 , & {C}_{x , y} ( m , n ) = 0 \\ 1 , & {C}_{x , y} ( m , n ) = 1\end{matrix} \qquad ( 3 )$$

The bit width conversion unit 1105 extends the bit width of the weight coefficient from 1 bit to 8 bits. If the value of the weight coefficient is represented in binary, equation (3) is given by:

$${C}_{x , y}^{′} ( m , n ) = \{ \begin{matrix}{( 11111111 )}_{2} , & {C}_{x , y} ( m , n ) = {( 0 )}_{2} \\ {( 00000001 )}_{2} , & {C}_{x , y} ( m , n ) = {( 1 )}_{2}\end{matrix} \qquad ( 4 )$$

The bit width of the weight coefficient C_{x,y}(m, n) before conversion is 1 bit, and no sign bit is added. The bit width of the weight coefficient C′_{x,y}(m, n) after conversion is 8 bits, and a sign bit is added. The weight coefficient is expressed by a 2's complement.

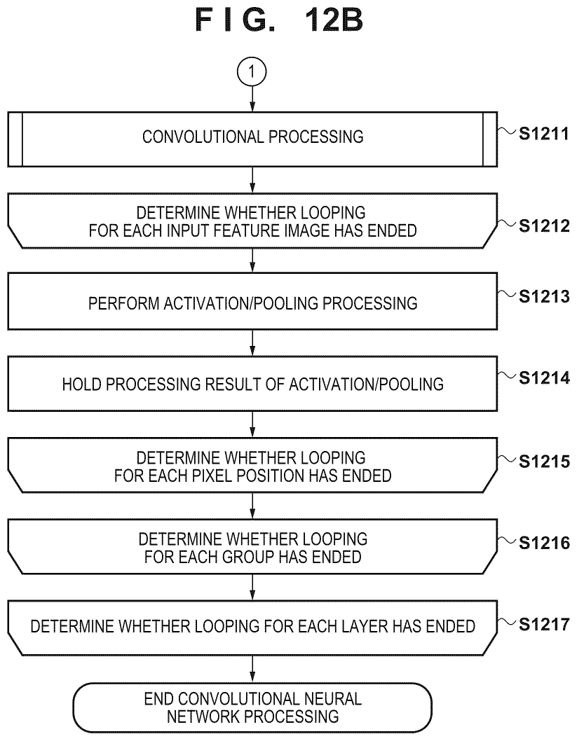

FIG. 13 is a block diagram showing an example of the arrangement of the bit width conversion unit 1105. The bit width conversion unit 1105 extends the bit width to 8 bits based on a switch signal of the bit width of the weight coefficient and the 1-bit weight coefficient.

If the bit width of the weight coefficient before conversion is 1 bit, a circuit 1301 converts the weight coefficient into an 8-bit weight coefficient in accordance with equation (4). As will be understood from equation (4), the least significant bit of the 8-bit weight coefficient after conversion is “1”. Furthermore, the remaining 7 bits all have a value obtained by inverting the 1-bit weight coefficient before conversion. Then, a selection unit 1302 selects a result of performing processing by the circuit 1301. Unlike normal bit extension, if the 1-bit weight coefficient C_{x,y}(m, n) is “0”, the value is converted, and if the 1-bit weight coefficient C_{x,y}(m, n) is “1”, the value is output intact. Therefore, the least significant bit is fixed to “1” without using an input signal.

On the other hand, if the bit width of the weight coefficient before conversion is 8 bits, the selection unit 1302 directly selects the 8-bit weight coefficient before conversion. As described above, the bit width conversion unit 1105 can simultaneously implement conversion of the value and extension of the bit width by a simple circuit.

As described above, according to the second embodiment, even if weight coefficients of different bit widths are mixed, it is possible to efficiently use the memory, similar to the first embodiment. Therefore, a weight coefficient of a small bit width (for example, 1 bit) is used in a layer or node in which recognition accuracy hardly lowers even if the bit width of a weight coefficient is decreased. This can reduce the memory capacity for holding the weight coefficients.

### Third Embodiment

The third embodiment will describe an arrangement of parallelly processing a plurality of arithmetic processes by one MAC arithmetic unit. Each of the first and second embodiments has explained the example of inputting and processing an input feature image for each channel to one MAC arithmetic unit. In the third embodiment, by parallelly processing a plurality of channels of input feature images, it is possible to reduce the processing time and reduce the power consumption. A description of the same configurations as those in the first or second embodiment will be omitted.

### Network Configuration

Assume that a CNN to be processed in the third embodiment has the same structure as in the first or second embodiment (FIG. 2). Note that a case where the bit widths of feature data and a weight coefficient are set for each layer as follows will be exemplified.

In layer 1, the bit width of feature data is 2 bits and the bit width of a weight coefficient is 1 bit. In layer 2, the bit width of feature data is 4 bits and the bit width of a weight coefficient is 1 bit. In layer 3, the bit width of feature data is 8 bits and the bit width of a weight coefficient is 1 bit. In layer 4, the bit width of feature data is 8 bits and the bit width of a weight coefficient is 8 bits.

### Arrangement of Convolutional Processing Unit

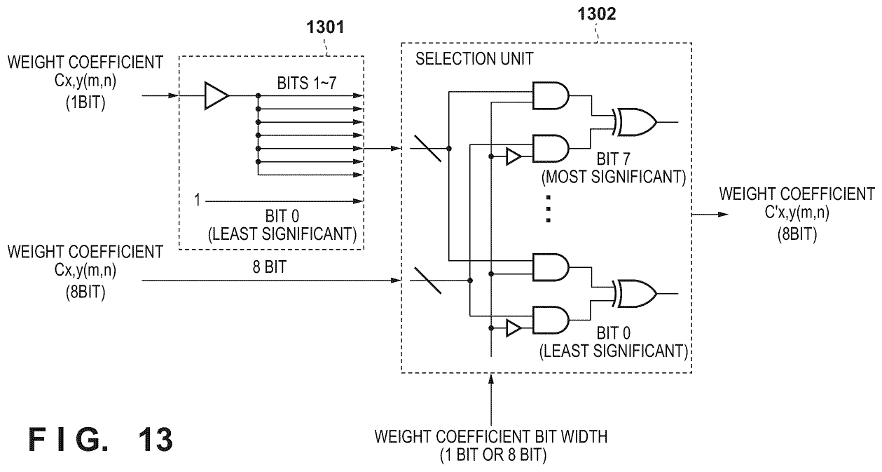

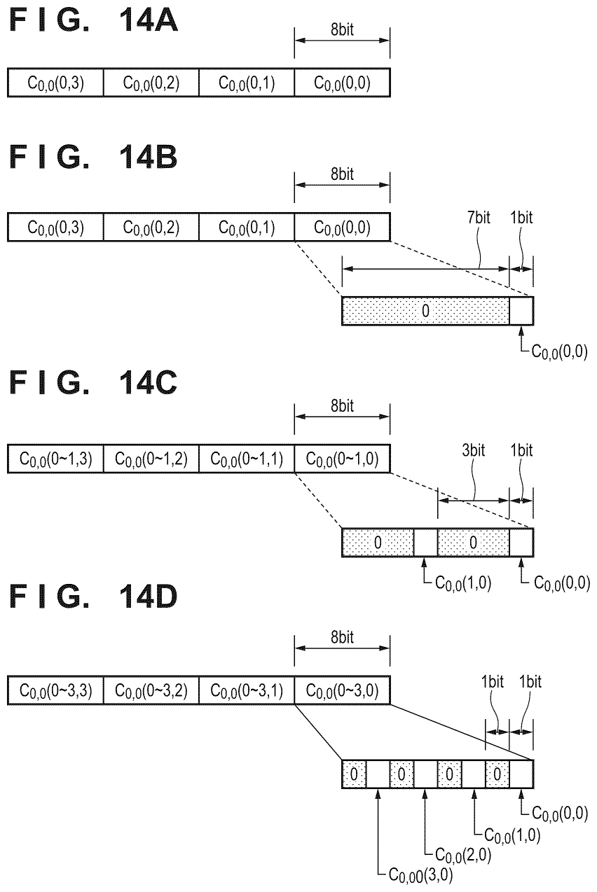

FIGS. 14A to 14D are views each showing the transfer format of weight coefficients according to the third embodiment. The arrangement of a convolutional processing unit 109 is the same as in the first embodiment (FIG. 3). A weight coefficient transfer unit 304 converts the format of weight coefficients in accordance with the bit width of each weight coefficient and parallelism (the number of parallel processes) in the channel direction of input feature images to be processed by the MAC arithmetic units, and transmits the weight coefficients to a parallel operation unit 305. More specifically, as will be described with reference to FIGS. 14A to 14D, the number of weight coefficients to be transmitted to the parallel operation unit 305 is obtained by multiplying the number (four) of MAC arithmetic units included in a MAC arithmetic unit group by the channel count of the input feature images to be parallelly processed.

FIG. 14A shows a transfer format in a case where the bit width of a weight coefficient is 8 bits. In this case, four weight coefficients are stored (that is, this is the same as in FIG. 9A). Each of FIGS. 14B to 14D shows a transfer format in a case where the bit width of a weight coefficient is 1 bit. Note that in FIGS. 14B and 14D, the division number (L) of the input feature images for parallel processing is different.

FIG. 14B shows a case where the input feature images as processing data are processed without division (the input channel count is 1). If the bit width processed by one MAC arithmetic unit is 8 bits, each of four weight coefficients is stored in the least significant bit for every 8 bits (that is, this is the same as in FIG. 9B).

FIG. 14C shows a case where the input feature images are divided into two groups and processed (the input channel count is two). If the bit width processed by one MAC arithmetic unit is 8 bits, 8 bits are divided into two parts, and each of weight coefficients corresponding to the input feature images to be parallelly processed is stored in the least significant bit for every 4 bits. If a MAC arithmetic unit group 600 includes four MAC arithmetic units, four MAC arithmetic unit groups are arranged.

FIG. 14D shows a case where input feature images are divided into four groups (the input channel count is four). If the bit width processed by one MAC arithmetic unit is 8 bits, 8 bits are divided into four parts, and each of weight coefficients corresponding to the input feature images to be parallelly processed is stored in the least significant bit for every 2 bits. If the MAC arithmetic unit group 600 includes four MAC arithmetic units, four MAC arithmetic unit groups are arranged.

As described above, the format of weight coefficients is converted and the weight coefficients are transferred to the parallel operation unit 305. This allows a weight coefficient separation unit 601 to distribute the weight coefficients for each input channel to each MAC arithmetic unit.

### Storage Operation and Storage Format of Weight Coefficients

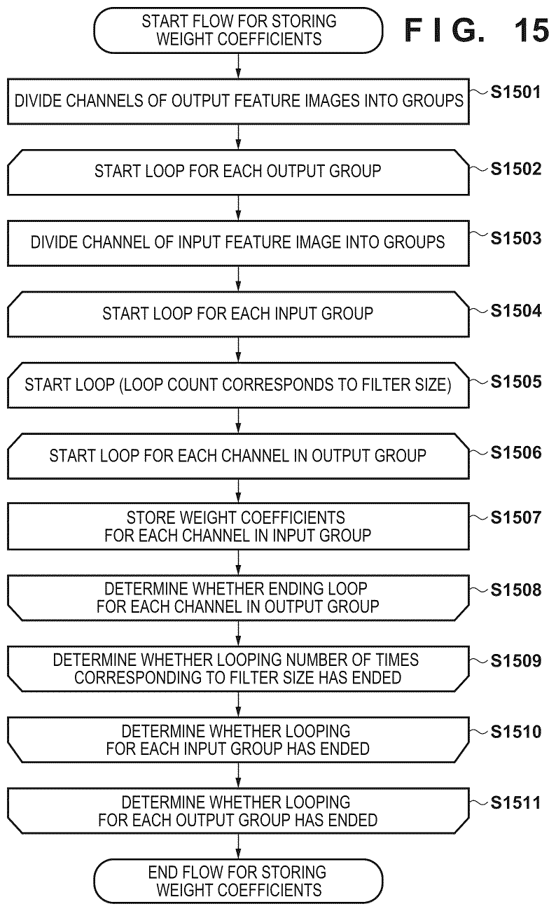

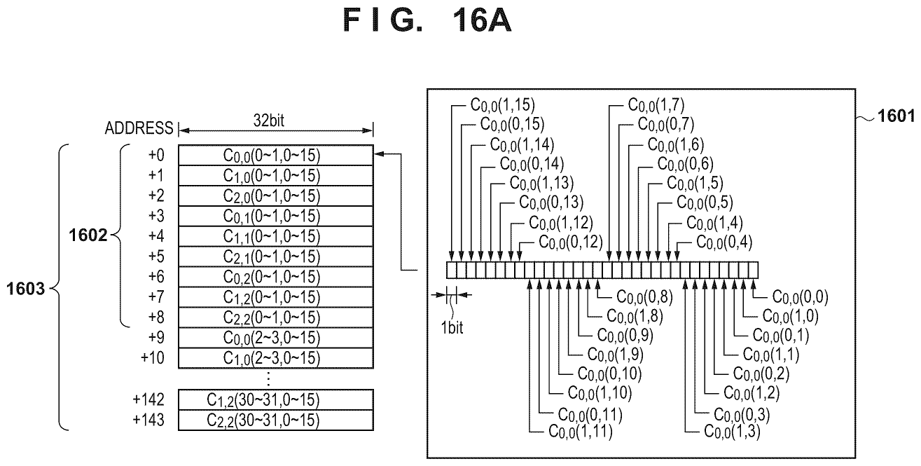

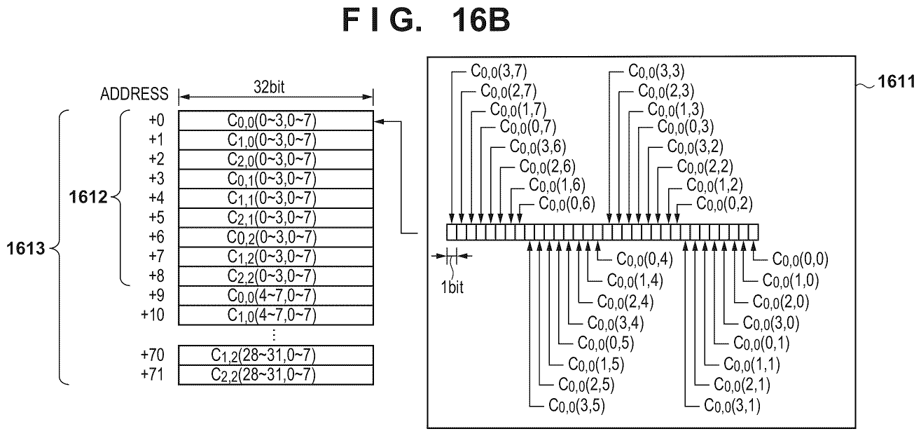

FIG. 15 is a flowchart of storing weight coefficients according to the third embodiment.

In step S1501, a control unit 306 divides channels of output feature images in a layer to be processed into a plurality of output groups. In the third embodiment, the channels of the output feature images are grouped by every number of weight coefficients fit in a bit width obtained by dividing “the word length of a weight coefficient memory 303” by “the channel count (IN) of input feature images to be parallelly processed by the MAC arithmetic unit”.

If one word includes 32 bits, a weight coefficient includes 1 bit, and the channel count of the input feature images to be parallelly processed is four, the channels are grouped by every eight channels that are fit in 8 bits obtained by dividing 32 bits by 4.

In step S1503, the control unit 306 groups the channels of the input feature images by every number of channels to be parallelly processed by one MAC arithmetic unit. If one MAC arithmetic unit parallelly processes two channels, the channels are grouped by every two channels. If one MAC arithmetic unit parallelly processes four channels, the channels are grouped by every four channels.

In step S1507, the control unit 306 stores weight coefficients as many as the number of channels of the input feature images grouped in step S1503. First, four channels of m=0 to 3 grouped in step S1503 are targets.

In step S1508, the control unit 306 determines whether a loop has been repeated as many times as the number of channels in an output group. If the weight coefficients have been stored for the output group, the process advances to step S1509. When storage of the weight coefficients for the output group ends, storage of weight coefficients for one word is complete. In this example, storage of data for 32 bits for storing 1-bit weight coefficients of m=0 to 3 and n=0 to 7is complete. If storage of the weight coefficients for the output group has not ended, the process returns to step S1506 to start storage of the next channel.

The structure of the weight coefficients stored in the weight coefficient memory 303 according to the flowchart shown in FIG. 15 will be described. 8-bit weight coefficients are stored in the weight coefficient memory 303 in the same storage format as in the first embodiment (FIG. 5). In a case where the bit width of a weight coefficient is 1 bit and the bits of the input feature images are not divided (the number of channels to be parallelly processed is 1), the weight coefficients are stored in the weight coefficient memory 303 in the same storage format as in the second embodiment (FIG. 10).

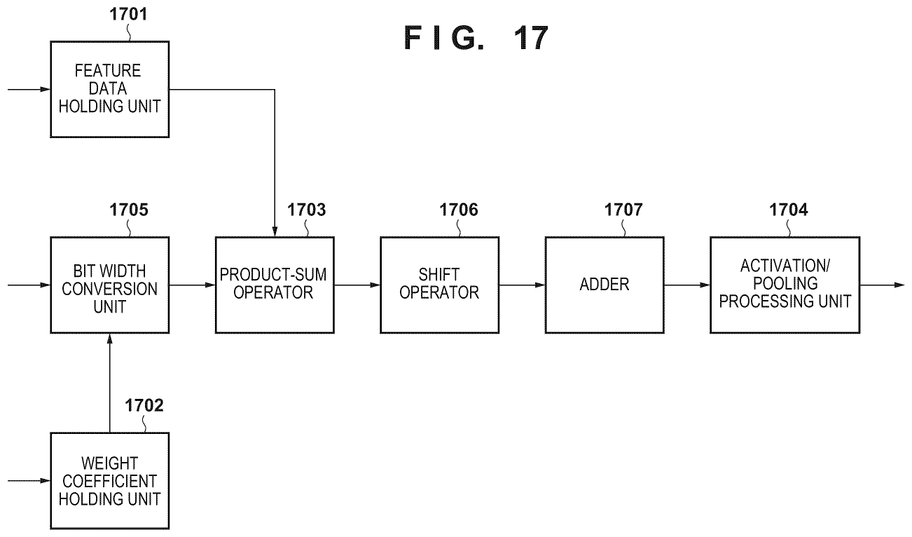

FIGS. 16A and 16B are views each showing an example of the storage format of weight coefficients according to the third embodiment. Each of FIGS. 16A and 16B especially shows an example of the storage format in a case where the number of channels of the input feature images to be parallelly processed is 2or 4. More specifically, the weight coefficient memory 303 holds a set of WD/(C×L) weight coefficients in each word area when the bit width of the weight coefficient is represented by C and the word length of the weight coefficient memory 303 is WD bits.

FIG. 16A shows a structure in a case where the bit width of the weight coefficient is 1 bit and the number of channels of the input feature image to be parallelly processed is two. In a case where the word length of the weight coefficient memory 303 is 32 bits, the bit width of the weight coefficient is 1 bit, and the number of channels to be parallelly processed is two, the channels of output feature images are grouped by every 16 (=32/2) channels in step S1501. In step S1503, the channels of the input feature images are grouped by every two channels corresponding to the number of channels to be parallelly processed. In step S1507, weight coefficients are stored for every two channels of the input feature images. The loop of steps S1506 to S1508 is repeated for 16 channels, and sets (C_{0,0}(0, 0) to C_{0,0}(1, 15)) of 16 weight coefficients are stored in a first word 1601.

FIG. 16B shows a structure in a case where the bit width of the weight coefficient is 1 bit and the number of channels of the input feature images to be parallelly processed is four. In a case where the word length of the weight coefficient memory 303 is 32 bits, the bit width of the weight coefficient is 1 bit, and the number of channels to be parallelly processed is four, the channels of output feature images are grouped by every 8 (=32/4) channels in step S1501. In step S1503, the channels of the input feature images are grouped by every four channels corresponding to the number of channels to be parallelly processed. In step S1507, weight coefficients are stored for every four channels of the input feature images. The loop of steps S1506 to S1508 is repeated for 8 channels, sets (C_{0,0}(0, 0) to C_{0,0}(3, 7)) of 8 weight coefficients are stored in a first word 1611.

### Arrangement of Parallel Operation Unit 305

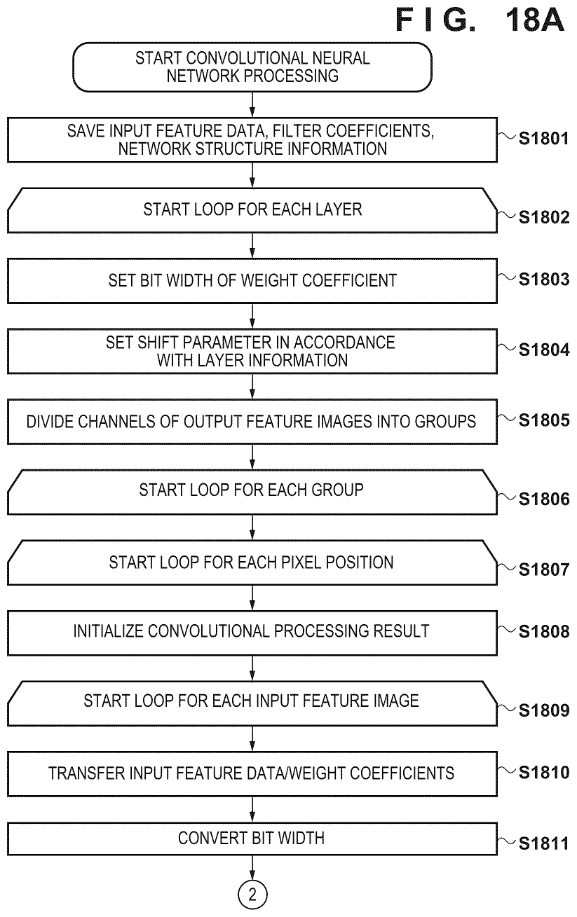

FIG. 17 is a block diagram showing an example of the arrangement of the MAC arithmetic unit according to the third embodiment. The MAC arithmetic unit according to the third embodiment has an arrangement obtained by adding a shift operator 1706 and an adder 1707 to the arrangement (FIG. 11) of the second embodiment.

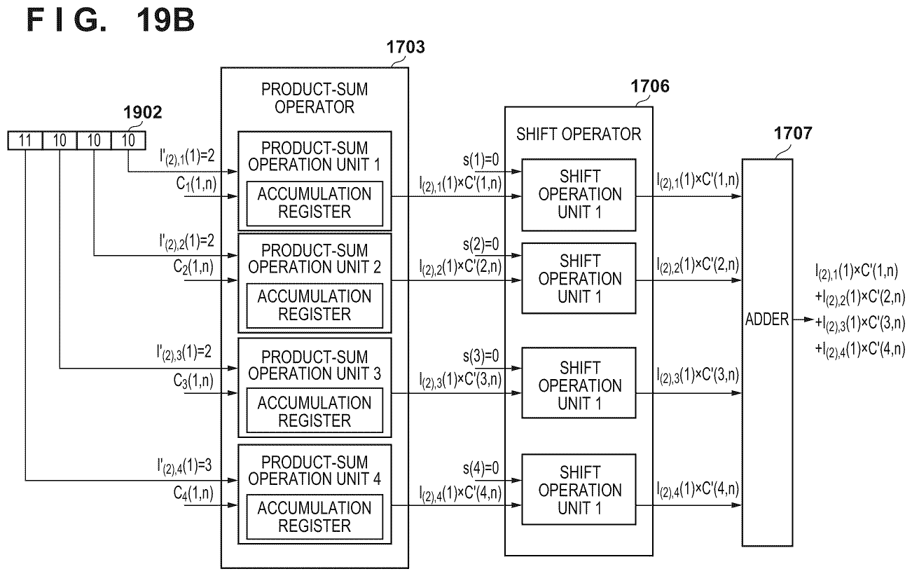

The shift operator 1706 performs processing of shifting (bit shift) the result of a product-sum operator 1703. The adder 1707 performs processing of adding a plurality of product-sum operation results. The product-sum operator 1703 is a component shown in FIGS. 19A and 19B (to be described later), and includes an accumulation register for each product-sum operation unit that performs processing by dividing input. This can perform parallel processing in the channel direction of the input feature image. In addition, it is possible to efficiently execute arithmetic processing along with the storage format of the weight coefficients.

### Arithmetic Processing Operation Using CNN

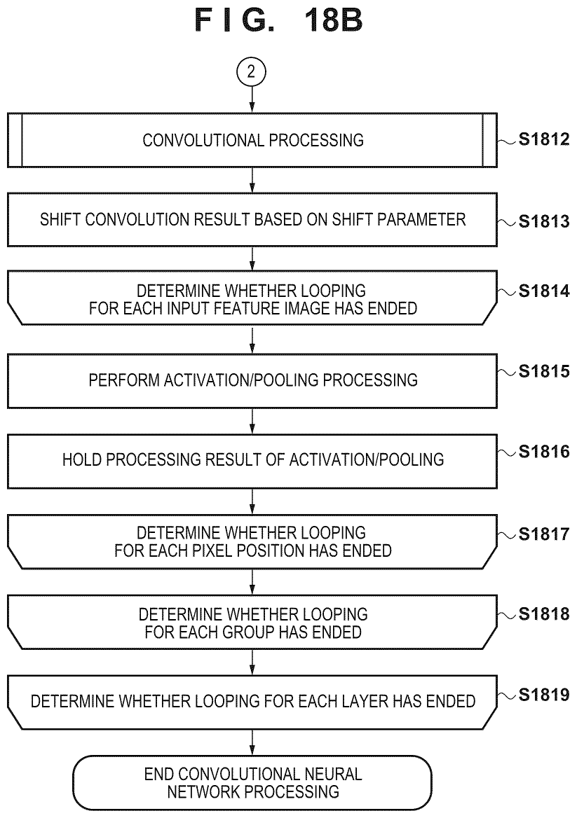

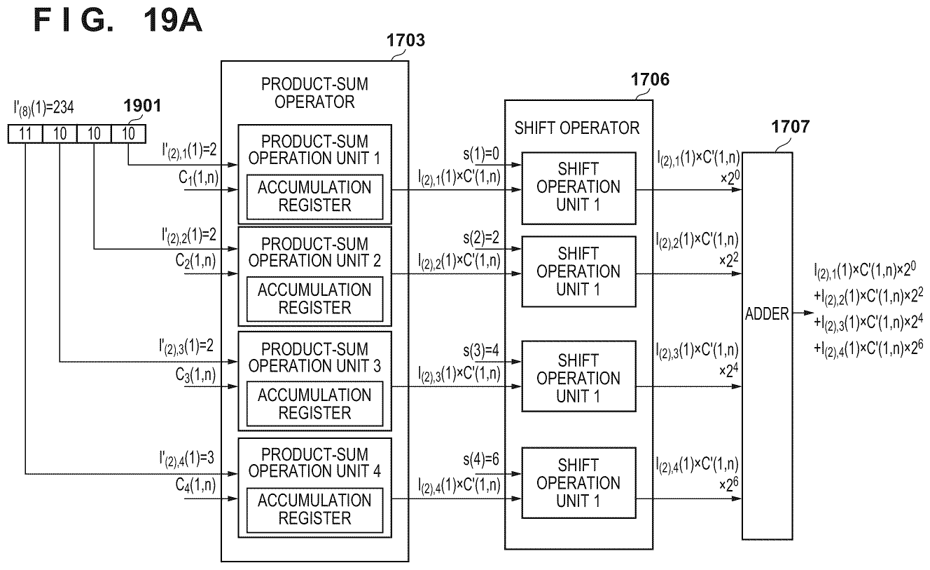

FIGS. 18A and B are a flowchart of CNN processing according to the third embodiment. The flowchart according to the third embodiment is obtained by adding steps S1804 and S1813 to the second embodiment (FIGS. 12A and 12B). Steps different from the second embodiment will be described below.

In step S1804, a control unit 306 sets the shift parameter of the shift operator 1706 in accordance with layer information. In step S1813, the shift operator 1706 shifts a product-sum operation result based on the shift parameter set in step S1804.

### Parallel Processing in Channel Direction of Input Feature Image

FIGS. 19A and 19B are views each showing an example of the operation of the MAC arithmetic unit according to the third embodiment. As described above, in the third embodiment, parallel processing is also performed in the channel direction of the input feature images by dividing the bits of the weight coefficient and the input feature data. Each of FIGS. 19A and 19B shows an example in which the feature data includes 8 bits or 2 bits.

As shown in FIG. 19A, in a case where the feature data includes 8 bits, the MAC arithmetic unit divides feature data 1901 (decimal value “234”; binary value “11101010”) by 2 bits. The product-sum operator 1703 calculates four product-sum operation results using the divided four 2-bit data (decimal values “2”, “2”, “2”, and “3”) and a common weight coefficient. The shift operator 1706 shifts the four product-sum operation results based on four shift parameters. The adder 1707 adds the four shifted product-sum operation results to calculate one feature data (the product-sum operation result of one 8-bit input feature data). In this way, the MAC arithmetic unit processes one 8-bit input feature data.

As shown in FIG. 19B, in a case where the feature data includes 2 bits, the MAC arithmetic unit divides feature data 1902 (decimal value “234”; binary value “11101010”) by 2 bits. The product-sum operator 1703 calculates four product-sum operation results using the divided four 2-bit data (decimal values “2”, “2”, “2”, and “3”) and four weight coefficients. The shift operator 1706 shifts the four product-sum operation results based on one shift parameter. In this example, since the shift parameter is zero, the results before and after the shift operation remain the same. The adder 1707 adds the four shifted product-sum operation results to calculate one feature data (the sum of the product-sum operation results of the four 2-bit input feature data). In this way, the MAC arithmetic unit parallelly processes four 2-bit input feature data.

As described above, by performing bit division and processing for feature data and a weight coefficient, it is possible to cope with a plurality of bit widths and parallelism. At this time, as indicated by the input 1901 (1-parallel data with an 8-bit width) and the input 1902 (4-parallel data with a 2-bit width), a value obtained by multiplying the bit width of one channel by the degree of parallelism is constant. This makes the transfer band of input data constant, and makes it easy to predict a band used for data transfer by the convolutional processing unit 109.

A case where the number of input feature images is M and a filter size is 1×1 will be described in more detail. Since the filter size is 1 pixel and the values of variables x, y are constants, Oi,j(n) is calculated using Ii,j(n). Calculation (equation (1)) of a product-sum operation is simplified by:

$$O ( n ) = {\sum }_{m = 1}^{M} ( I ( m ) \times C ( m , n ) ) \qquad ( 5 )$$

If the filter size is larger than 1×1, the product-sum operator calculates a weight coefficient and the convolutional operation result of the input feature data. However, if the filter size is 1×1, the product-sum operator calculates the product of I(m) and C(m, n).

Assume that the feature data to be processed include two types of data whose bit widths are α bits and β bits (β>α). Assume also that the product-sum operator 1703 includes P product-sum operation units and P shift operation units. α, β, and P satisfy a condition given by;

$$β = α \times P \qquad ( 6 )$$

In a case where the bit width of input feature data I′(β) is β bits, the output of the adder 1707 is given by:

$$O ( n ) = {\sum }_{m = 1}^{M} {\sum }_{p = 1}^{P} [ ( {I}_{( α ) , p} ( m ) \times {C}_{p} ( m , n ) ) \times {2}^{S ( p )} ] \qquad ( 7 )$$

where O(n) represents the product-sum operation result of the nth output feature image, I_{(α),p}(m) represents the input data of the product-sum operation unit of α-bit data, Cp(m, n) represents a weight coefficient, and S(p) represents a shift parameter. A variable m represents the number (the processing number of the product-sum operator 1703) of an α-bit input feature image group (1 group=P images), and a variable p represents the number of each of the product-sum operation unit and the shift operation unit, and a variable n represents the number of an output feature image. The shift operation is expressed by the power of 2.

The weight coefficient Cp(m, n) is a weight coefficient C′(m, n) corresponding to the mth β-bit feature image. Since the α-bit input feature image group shares a weight coefficient, p can be omitted. The number of weight coefficients parallelly supplied to the P produce-sum operation units is one, and the number of times of transfer is one.

$${C}_{p} ( m , n ) = {C}^{'} ( m , n ) \qquad ( 8 )$$

In this example, the input feature data I′(β) is divided into P α-bit data I_{(α),p}(m). The value of the shift parameter S(p) is calculated based on the number p of the product-sum operation unit and the bit width α of the divided data, given by:

$$S ( p ) = α \times ( p - 1 ) \qquad ( 9 )$$

The β-bit input feature data I′(β) is expressed by the divided P α-bit data I_{(α),p}(m).

$${\sum }_{p = 1}^{P} {I}_{( α ) , p} ( m ) \times {2}^{S ( p )} = {{I}^{'}}_{( β )} ( m ) \qquad ( 10 )$$

By substituting equations (8) to (10) into equation (7), the calculation formula of the output data O(n) is given by:

$$O ( n ) = {\sum }_{m = 1}^{M} {\sum }_{p = 1}^{P} [ ( {I}_{( α ) , p} ( m ) \times {C}_{p} ( m , n ) ) \times {2}^{α \times ( p - 1 )} ] = {\sum }_{m = 1}^{M} ( {{I}^{'}}_{( β )} ( m ) \times {C}^{'} ( m , n ) ) \qquad ( 11 )$$

On the other hand, in a case where the bit width of the input feature data I′(α) is α bits, the output of the adder 1707 is given by:

$$O ( n ) = {\sum }_{m = 1}^{\frac{M}{P}} {\sum }_{p = 1}^{P} [ ( {I}_{( α ) , p} ( m ) \times {C}_{p} ( m , n ) ) \times {2}^{S ( p )} ] \qquad ( 12 )$$

where O(n) represents the product-sum operation result of the nth output feature image, I_{(α),p}(m) represents the input data of the product-sum operation unit of α-bit data, Cp(m, n) represents the weight coefficient, and S(p) represents the shift parameter. The variable m represents the number (the processing number of the product-sum operator 1703) of the α-bit input feature image group (1 group=P images), and the variable p represents the number of each of the product-sum operation unit and the shift operation unit, and the variable n represents the number of the output feature image. The shift operation is expressed by the power of 2.

The weight coefficient Cp(m, n) is a weight coefficient C′((m−1)×P+p,n) corresponding to the ((m−1)×P+p)th α-bit feature image. Since the weight coefficient is different depending on the number p of the product-sum operation unit, the number of weight coefficients parallelly supplied to the P produce-sum operation units is P, and the number of times of transfer is P.

$${C}_{p} ( m , n ) = {C}^{'} ( ( m - 1 ) \times P + p , n ) \qquad ( 13 )$$

The input feature data I′(α) is input data I_{(α),p}(m) of the product-sum operation unit of the α-bit data, and the value of the shift parameter S(p) is 0.

$$S ( p ) = 0 \qquad ( 14 )$$

The P α-bit input feature data I′(α) are input to the product-sum operation units intact but the P input data are feature data of different feature images. The number of each feature image is expressed by the number p of the product-sum operation unit, the number P of product-sum operation units, and the processing number m of the product-sum operator 1703.

$${I}_{( α ) , p} ( m ) = {{I}^{'}}_{( α )} ( ( m - 1 ) \times P + p ) \qquad ( 15 )$$

By substituting equations (13) to (15) into equation (12), the calculation formula of the output data O(n) is given by:

$$O ( n ) = {\sum }_{m = 1}^{\frac{M}{P}} {\sum }_{p = 1}^{P} [ ( {{I}^{'}}_{( α ) , p} ( ( m - 1 ) \times P + p ) \times {C}^{'} ( ( m - 1 ) \times P + p , n ) ] \qquad ( 16 )$$

The value of the shift parameter S(p) and the number of weight coefficients are changed. As described above, the same MAC arithmetic unit can process the feature data I′(α) with a bit width of a bits and the feature I′(β) with a bit width of β bits.

### Modification

Each of the first and second embodiments has described an arrangement of performing parallel processing in the channel direction of an output feature surface. The third embodiment has described an arrangement of also performing parallel processing in the channel direction of an input feature surface. As a modification, the setting of the operation mode of the convolutional processing unit 109 may be configured to be dynamically changed. For example, the convolutional processing unit 109 may be configured to include a register for setting the operation mode, and the value in the register may be changed in accordance with a network configuration, thereby making it possible to switch the operation described in each of the first to third embodiments.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-082484, filed May 18, 2023 which is hereby incorporated by reference herein in its entirety.

What is claimed is:

1. An apparatus comprising:
an operation unit including M (M is an integer not less than 2) product-sum operators that can operate in parallel;
a memory configured to hold a plurality of coefficients used by the operation unit; and
a transfer unit configured to transfer the coefficients held in the memory to the operation unit,
wherein the memory holds the plurality of coefficients in accordance with an order of output channels of the operation unit and word alignment of the memory, and
in a case where the operation unit parallelly executes N (N is a positive integer not more than M) arithmetic processes, the transfer unit transfers at least N coefficients to the operation unit in a predetermined transfer format.

2. The apparatus according to claim 1, wherein
the predetermined transfer format includes M fixed-length fields, and
the transfer unit stores M coefficients in the M fixed-length fields and transfers the M coefficients to the operation unit.

3. The apparatus according to claim 2, wherein the operation unit further includes a separation unit configured to separate the M coefficients included in the predetermined transfer format and transmit the M coefficients to the M product-sum operators.

4. The apparatus according to claim 1, wherein
the memory holds a plurality of coefficients including a first coefficient of a bit width CA and a second coefficient of a bit width CB, and
in a case where a word length of the memory is WD bits, the memory holds WD/CA first coefficients or WD/CB second coefficients in each word area.

5. The apparatus according to claim 4, wherein the operation unit is configured to switch between a first mode of performing processing using the first coefficient and a second mode of performing processing using the second coefficient.

6. The apparatus according to claim 1, wherein
each of the M product-sum operators performs parallel processing by dividing processing data into L (L is a positive integer) input channels,
the memory holds the coefficients in an order of output channels of the corresponding product-sum operator for each input channel, and
the transfer unit transfers at least N×L coefficients to the operation unit in the predetermined transfer format.

7. The apparatus according to claim 6, wherein in a case where a bit width of a coefficient is represented by C and a word length of the memory is WD bits, the memory holds a set of WD/(C×L) coefficients in each word area.

8. The apparatus according to claim 6, wherein the operation unit is configured to switch a value of L.

9. The apparatus according to claim 1, wherein the operation unit is an operation unit forming a convolutional neural network (CNN).

10. An apparatus comprising:
an operation unit including M (M is an integer not less than 2) product-sum operators that can operate in parallel;
a memory configured to hold a plurality of coefficients used by the operation unit; and
a transfer unit configured to transfer the coefficients held in the memory to the operation unit,
wherein the memory holds the plurality of coefficients in accordance with an order of output channels of the operation unit and word alignment of the memory and
wherein the memory holds a plurality of coefficients including a first coefficient of a bit width CA and a second coefficient of a bit width CB.

11. The apparatus according to claim 10, wherein, in a case where the operation unit parallelly executes N (N is a positive integer not more than M) arithmetic processes, the transfer unit transfers at least N coefficients to the operation unit in a predetermined transfer format.

12. The apparatus according to claim 11, wherein
the predetermined transfer format includes M fixed-length fields, and
the transfer unit stores M coefficients in the M fixed-length fields and transfers the M coefficients to the operation unit.

13. The apparatus according to claim 12, wherein the operation unit further includes a separation unit configured to separate the M coefficients included in the predetermined transfer format and transmit the M coefficients to the M product-sum operators.

14. The apparatus according to claim 11, wherein, in a case where a word length of the memory is WD bits, the memory holds WD/CA first coefficients or WD/CB second coefficients in each word area.

15. The apparatus according to claim 14, wherein the operation unit is configured to switch between a first mode of performing processing using the first coefficient and a second mode of performing processing using the second coefficient.

16. The apparatus according to claim 11, wherein
each of the M product-sum operators performs parallel processing by dividing processing data into L (L is a positive integer) input channels,
the memory holds the coefficients in an order of output channels of the corresponding product-sum operator for each input channel, and
the transfer unit transfers at least N×L coefficients to the operation unit in the predetermined transfer format.

17. The apparatus according to claim 16, wherein in a case where a bit width of a coefficient is represented by C and a word length of the memory is WD bits, the memory holds a set of WD/(C×L) coefficients in each word area.

18. The apparatus according to claim 16, wherein the operation unit is configured to switch a value of L.

19. The apparatus according to claim 11, wherein the operation unit is an operation unit forming a convolutional neural network (CNN).
